(19) United States
(12) Patent Application Publication
(10) Pub. No.: US 2008/0003031 A1
(43) Pub. Date: Jan. 3, 2008

(54) SHEET CONVEYING APPARATUS AND IMAGE FORMING APPARATUS USING THE SHEET CONVEYING APPARATUS

(76) Inventors: Kiyomi Tsuchiya, Hitachinaka-shi (JP); Nobuyuki Furuya, Hitachinaka-shi (JP); Yoshihiko Sano, Hitachinaka-shi (JP); Takayuki Muneyasu, Hitachinaka-shi (JP); Takeshi Uchida, Hitachinaka-shi (JP)

Correspondence Address: Harness, Dickey & Pierce, P.L.C., P.O. Box 8910, Reston, VA, 20195, US

(21) Appl. No.: 11/766,173

(22) Filed: Jun. 21, 2007

(30) Foreign Application Priority Data
Jun. 21, 2006 (JP) JP2006-171716
Apr. 20, 2007 (JP) JP2007-111510

(51) Int. Cl. G03G 15/00

(52) U.S. Cl. 399/361; 399/134; 399/66

(57) ABSTRACT

A sheet conveying apparatus includes: a gate member configured to selectively block a sheet conveyance path thereby providing a structure against which to locate a leading edge of a sheet of an image-bearing medium; resist rollers provided upstream in a sheet conveyance direction vis-à-vis the gate member and configured to convey the sheet downstream to the gate member in the sheet conveyance direction; a detector provided downstream in the sheet conveyance direction vis-à-vis the gate member and configured to detect misalignment at an edge portion of the sheet in a sheet width direction perpendicular to the sheet conveyance direction; a moving mechanism, including a motor, configured to move the resist rollers in the sheet width direction; and a controller configured to change control the moving mechanism by changing a drive mode and a rotation speed of the motor in accordance with a sheet misalignment amount detected by the detector.

### PRIORITY STATEMENT

The present patent application claims priority under 35 U.S.C. §119 upon Japanese patent applications, Nos. 2006-171716 filed on Jun. 21, 2006 and 2007-111510 filed on Apr. 20, 2007 in the Japan Patent Office, the entire contents of which are incorporated by reference herein.

### BACKGROUND

1. Field

This patent specification generally describes a paper conveying apparatus and an image forming apparatus using the paper conveying apparatus.

2. Discussion of the Background

Conventional multicolor image forming apparatuses such as full color printers and spot color printers that produce multicolor images generally employ a tandem method for image forming. In the tandem method, a plurality of photoconductive drums is provided along a moving direction of an endless intermediate transfer belt. The photoconductive drums are charged and exposed to light to form electrostatic latent images thereon. The electrostatic latent images formed on the respective photoconductive drums are developed with toners of different colors to form toner images. The toner images are sequentially transferred to and are superimposed on the intermediate transfer belt. The superimposed toner image is conveyed by the intermediate transfer belt, is transferred onto paper at an image transfer position, and is then fixed on the paper.

Such an image forming apparatus is generally configured to convey paper stocked in a paper feed unit one by one toward the image transfer position. To position the toner image on the paper at the image transfer position, resist rollers placed upstream of the image transfer position in a paper conveyance direction are known to be used. The resist rollers stop the paper, and are then driven to feed the paper toward the image transfer position in synchronization with conveyance of the toner image on the intermediate transfer belt.

When a leading edge of paper is not perpendicular to the paper conveyance direction and the paper is obliquely conveyed from the paper feed unit, the leading edge of the paper is corrected at a nip between the resist rollers by contacting the leading edge of the paper against the nip between the resist rollers which are not driven, pushing the paper further, and bowing the paper.

Alternatively, in a conventional method, a gate device for positioning paper in a direction perpendicular to a paper conveyance direction is provided on a paper conveyance path. The gate device stops paper and corrects a paper position by contacting a leading edge of the paper against the gate device. However, in this method, resist rollers are provided just behind the gate device in the paper conveyance direction. After the gate device is opened, pushing paper that has a curled leading edge into a nip between the resist rollers is difficult and causes a problem such as paper misfeed and a crumpled leading edge. Also, when a leading edge portion of paper is deflected by contacting the gate device, pushing the deflected leading edge into the nip between the resist rollers is also difficult.

There is another conventional method in which a gate device is provided downstream of resist rollers in a paper conveyance direction. A leading edge of paper contacts the gate device and is positioned while the resist rollers are separated from each other. Then, the resist rollers contact each other to sandwich the paper therebetween, and the gate device is opened. The paper is conveyed toward an image transfer position by the resist rollers. A leading edge portion of paper positioned by the gate device is sandwiched between the resist rollers, and therefore, the paper is conveyed toward the image transfer position without causing misalignment of the paper after the paper is positioned.

However, in this method, paper is conveyed toward the image transfer position by using the resist rollers as a final mechanism to convey the paper after the gate device is opened. To prepare for a next sheet of paper, the resist rollers need to be separated from each other and the gate device needs to be closed after the resist rollers complete conveyance of the previous sheet of paper, that is, after a trailing edge of the previous sheet of paper passes the resist rollers. Consequently, it is difficult or impossible to perform high speed printing.

In other words, a slowed paper feed rate prevents high speed operation of an image forming apparatus.

### SUMMARY

An embodiment of the present invention provides a sheet conveying apparatus comprising: a gate member configured to selectively block a sheet conveyance path thereby providing a structure against which to locate a leading edge of a sheet of an image-bearing medium; resist rollers provided upstream in a sheet conveyance direction vis-à-vis the gate member and configured to convey the sheet downstream to the gate member in the sheet conveyance direction; a detector provided downstream in the sheet conveyance direction vis-à-vis the gate member and configured to detect misalignment at an edge portion of the sheet in a sheet width direction perpendicular to the sheet conveyance direction; a moving mechanism, including a motor, configured to move the resist rollers in the sheet width direction; and a controller configured to change control the moving mechanism by changing a drive mode and a rotation speed of the motor in accordance with a sheet misalignment amount detected by the detector.

At least one embodiment of the present invention provides an image forming apparatus that includes such a paper conveying apparatus mentioned above.

### BRIEF DESCRIPTION OF THE DRAWINGS

A more complete appreciation of the disclosure and many of the attendant advantages thereof will be readily obtained as the same becomes better understood by reference to the following detailed description of example embodiments when considered in connection with the accompanying drawings, wherein:

FIG. 1 illustrates schematically a four-color image forming apparatus according to an example embodiment of the present invention;

FIG. 2A illustrates schematically (according to an example embodiment of the present invention) a paper conveying apparatus, e.g., for use with FIG. 1, and FIG. 2B illustrates (according to an example embodiment of the present invention) a top schematic view of the paper conveying apparatus;

FIGS. 3-6, 7A, 7B, 8A, 8B, 9A, 9B and 10 illustrate (according to an example embodiment of the present invention) a paper positioning operation of the paper conveying apparatus;

FIG. 11A illustrates (according to an example embodiment of the present invention) a state in which a unit frame is positioned at a home position, FIG. 11B illustrates (according to an example embodiment of the present invention) a state in which a cam is rotated in a counterclockwise direction by 90 degrees, and FIG. 11C illustrates (according to an example embodiment of the present invention) a state in which the cam is rotated in a clockwise direction by 90 degrees;

FIGS. 12A and 12B illustrate (according to an example embodiment of the present invention) a table of movement increments (per step, respectively) in 1-2 phase excitation mode;

FIG. 13 illustrates (according to an example embodiment of the present invention) a table of movement increments (per step, respectively) in 2-phase excitation mode;

FIG. 14 illustrates (according to an example embodiment of the present invention) a drive mechanism to move resist rollers, to rotate the resist rollers, and to move the unit frame including the resist rollers;

FIG. 15 is a flow chart illustrating (according to an example embodiment of the present invention) an operation of changing a drive mode and a rotation speed of a vertical drive motor;

FIG. 16 is a flow chart illustrating (according to an example embodiment of the present invention) an operation of selecting to change the drive mode and the rotation speed of the vertical drive motor;

FIG. 17 is a flow chart illustrating (according to an example embodiment of the present invention) an operation of driving the vertical drive motor by controlling the rotation speed;

FIG. 18 is a flow chart illustrating (according to an example embodiment of the present invention) an operation of driving the vertical drive motor; and

FIGS. 19A and 19B are a flow chart illustrating (according to an example embodiment of the present invention) an operation of preventing the vertical drive motor from driving.

### DETAILED DESCRIPTION OF EXAMPLE EMBODIMENTS

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, a paper positioning operation of a paper conveying apparatus according to an embodiment of the present invention is described.

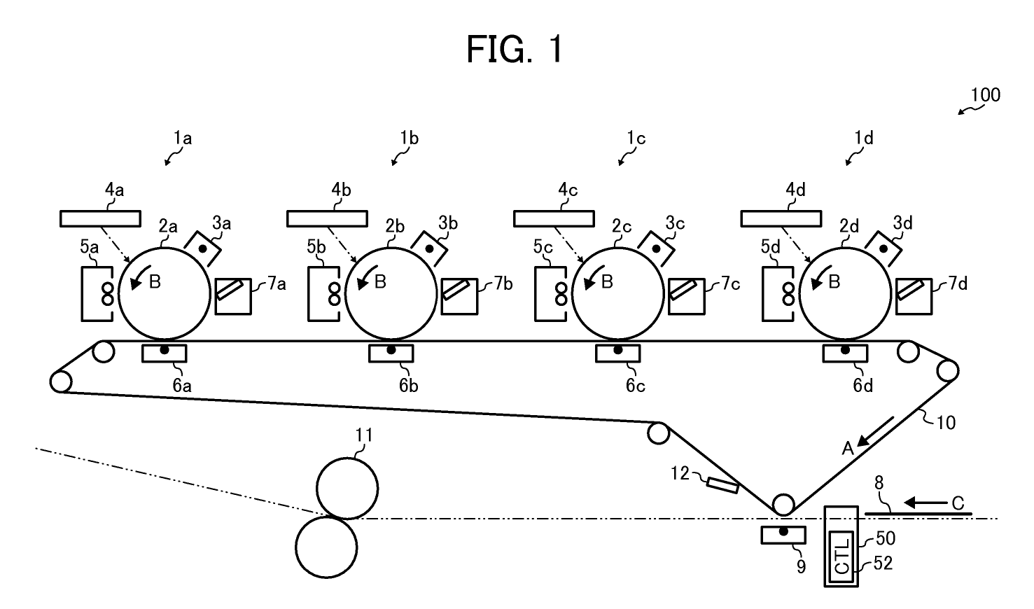

FIG. 1 illustrates schematically a four-color image forming apparatus 100 as an image forming apparatus using a paper conveying apparatus 50 (including a controller 52) according to an embodiment of the present invention.

The image forming apparatus 100 includes four image forming units 1a, 1b, 1c, and 1d provided along a moving direction of a transfer belt 10 indicated by an arrow A in FIG. 1. The image forming unit 1a includes a photoconductive drum 2a, a charging device 3a, an exposure device 4a, a development device 5a, a transfer device 6a, a cleaning device 7a, and so on. The photoconductive drum 2a operates as an image carrier. The image forming units 1b through 1d are configured in a similar way to the image forming unit 1a.

The image forming units 1a through 1d are configured to form images of different colors, respectively. For example, the image forming unit 1a forms a yellow image, the image forming unit 1b forms a magenta image, the image forming unit 1c forms a cyan image, and the image forming unit 1d forms a black image.

When receiving an instruction signal from a printer control unit, not shown, to start an image forming operation, the photoconductive drum 2a starts to rotate in a direction indicated by an arrow B in FIG. 1 and continues to rotate until the image forming operation is completed. When the photoconductive drum 2a starts to rotate, high voltage is applied to the charging device 3a, and a surface of the photoconductive drum 2a is uniformly negatively charged. Then, when data such as character data and graphic data is converted into dot image and is transmitted as an on-off signal of the exposure device 4a from the printer control unit, not shown, to the image forming apparatus 100, a portion of the surface of the photoconductive drum 2a which is exposed to laser light emitted from the exposure device 4a and a portion of the surface of the photoconductive drum 2a which is not exposed to the laser light are formed on the surface of the photoconductive drum 2a. When the laser irradiated portion on the photoconductive drum 2a where the charge is reduced by the exposure of the laser light emitted from the exposure device 4a reaches a position facing the development device 5a, a negatively charged toner is attracted to the laser irradiated portion, resulting in formation of a toner image.

When the toner image formed on the photoconductive drum 2a reaches a position of the transfer device 6a that operates as a primary transfer mechanism, the toner image is transferred onto the transfer belt 10 rotating in the arrow A direction in FIG. 1 by high voltage applied to the transfer device 6a. After the toner image passes a transfer position of the toner image, a residual toner, which is not transferred and remains on the photoconductive drum 2a, is removed by the cleaning device 7a to prepare for a next image forming operation.

Subsequently, the image forming unit 1b also performs an image forming operation in a similar way to the image forming unit 1a. A toner image formed on a photoconductive drum 2b is transferred onto the transfer belt 10 by high voltage applied to a transfer device 6b.

The toner image formed on the photoconductive drum 2b is transferred onto the transfer belt 10 when the toner image which is formed by the image forming unit 1a and is transferred onto the transfer belt 10 reaches a position of the transfer device 6b. Consequently, the toner image formed by the image forming unit 1a is superimposed on the toner image formed by the image forming unit 1b on the transfer belt 10. Similarly, by superimposing toner images formed by the image forming units 1c and 1d on the transfer belt 10, a full color image is formed on the transfer belt 10.

The full color image is conveyed to a paper transfer device 9 that operates as a secondary transfer mechanisms, and simultaneously, paper 8 is conveyed in a direction indicated by an arrow C in FIG. 1 from a paper feed unit, not shown, of the image forming apparatus 100 and reaches a position of the paper transfer device 9. Here, the term “paper” is used very generally to refer to one or more sheets of an image-bearing medium, e.g., cellulose pulp based paper, polymer sheets, etc. The full color image on the transfer belt 10 is transferred onto the paper 8 by high voltage applied to the paper transfer device 9. When the paper 8 is conveyed to a fixing device 11, the full color image on the paper 8 is melted and fixed on the paper 8. After the full color image passes the position of the paper transfer device 9, a residual toner, which is not transferred and remains on the transfer belt 10, is removed by a belt cleaning mechanism 12.

The paper conveying apparatus 50, which is provided upstream of the paper transfer device 9 in a paper conveyance direction, and a paper positioning operation thereof are now described in detail.

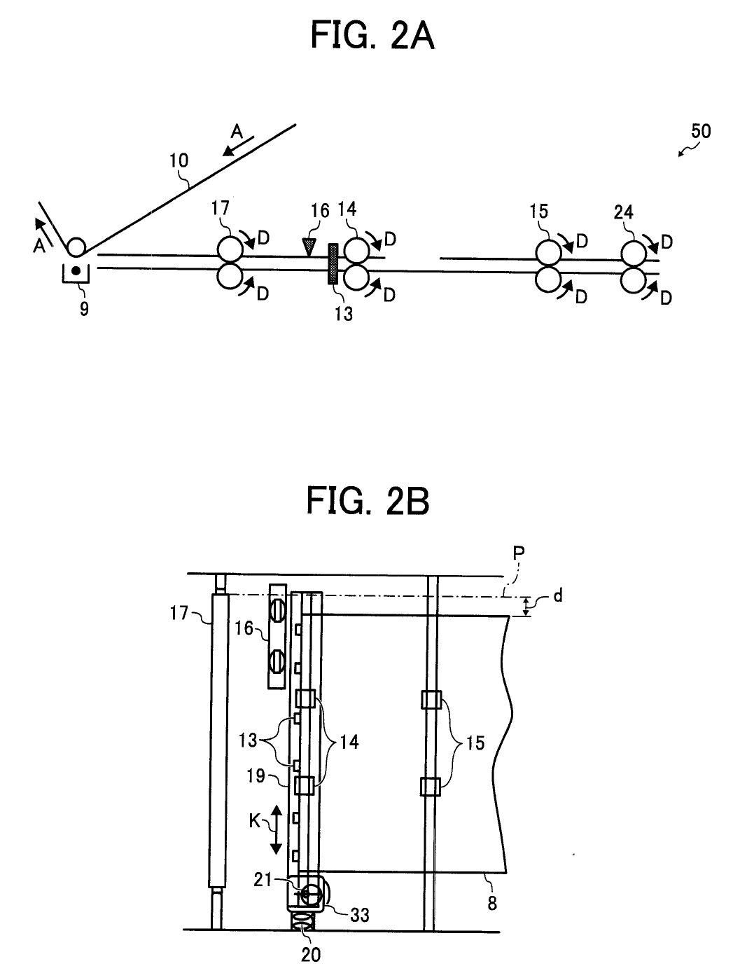

FIG. 2A illustrates schematically the paper conveying apparatus 50 of FIG. 1 and FIG. 2B illustrates a top schematic view of the paper conveying apparatus 50. As illustrated in FIGS. 2A and 2B, the paper conveying apparatus 50 of the present embodiment includes the controller 52 (see FIG. 1), a gate device 13, resist rollers 14, conveyance rollers 15, a paper detector 16, timing rollers 17, conveyance rollers 24, and so on. A leading edge of paper contacts the gate device 13 to be positioned. The resist rollers 14 are provided near the gate device 13 on an upstream side in the paper conveyance direction. The upstream side in the paper conveyance direction is simply referred to as “upstream” hereinafter in the present specification. The conveyance rollers 15 are provided upstream of the resist rollers 14. The paper detector 16 for detecting paper misalignment is provided on a downstream side of the gate device 13 in the paper conveyance direction and between the gate device 13 and an image transfer position where an image is transferred onto the paper. The downstream side in the paper conveyance direction is simply referred to as “downstream” hereinafter in the present specification. The timing rollers 17 are provided downstream of the paper detector 16.

The resist rollers 14 are capable of contacting (or pressing against) each other and being separated from each other by an opening and closing motor 30, which is described later. Similarly, the conveyance rollers 15 are capable of contacting (or pressing against) each other and being separated from each other by a drive mechanism not shown. The conveyance rollers 24 are provided upstream of the conveyance rollers 15. The resist rollers 14, the conveyance rollers 15, the timing rollers 17, and the conveyance rollers 24 rotate as indicated by arrows D in FIG. 2A, respectively.

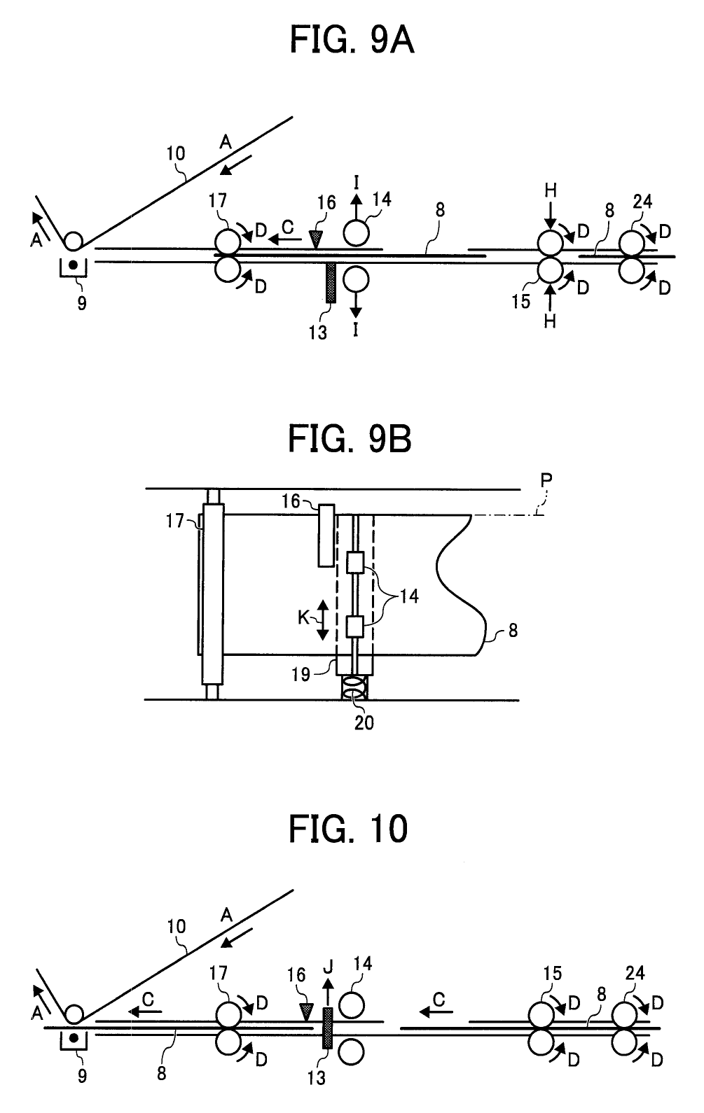

That the resist rollers are provided near the gate member on an upstream side in a paper conveyance direction should be understood as the resist rollers being provided near the gate member on an upstream side in a paper conveyance direction with respect to the position of the gate member. Similarly, that the detector is provided near the gate member on a downstream side in the paper conveyance direction should be understood as the detector being provided near the gate member on a downstream side in the paper conveyance direction with respect to the position of the gate member. As shown in FIG. 4, the paper conveyance path has an opening or is alternatively widened in order to allow the transported paper 8 to be bowed. The term “object 1 near to object 2” is preferably interpreted as “object 1 adjacent to object 2” where in the objects 1 and 2 are in touch with each other or are not in touch with each other. Since the resist rollers 14 as shown in FIG. 9A do not act as timing rollers, too, but instead, separate timing rollers 17 are provided downstream of the gate device and of the resist rollers 14, it is possible to start separating the resist rollers 14 from each other while the timing rollers 17 are still pressed against each other. Another paper 8 can therefore be earlier transported to the resist rollers 14 compared to a situation where the resist rollers also act as timing rollers. This allows for high speed conveyance of papers and therefore for high speed printing.

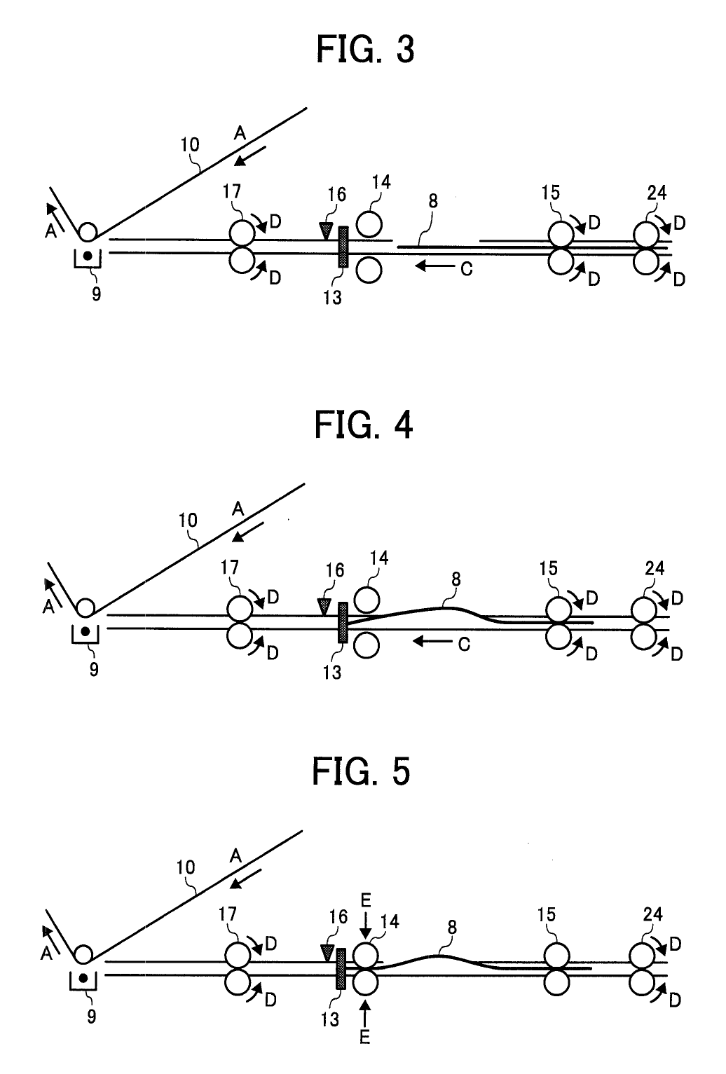

Next, a paper positioning operation of the paper conveying apparatus 50 is described. FIGS. 3 through 10 illustrate a paper positioning operation of the paper conveying apparatus 50. Paper 8 fed from the paper feed unit, not shown, is conveyed by the conveyance rollers 24, the conveyance rollers 15, and so on, in a direction indicated by an arrow C in FIG. 3 toward the gate device 13 at a specified speed. The resist rollers 14 are separated from each other and the gate device 13 is closed before the paper 8 reaches the resist rollers 14.

The paper 8 is further conveyed and a leading edge of the paper 8 contacts the gate device 13. While the leading edge of the paper 8 is contacting the gate device 13, a trailing edge of the paper 8 is further conveyed downstream by the conveyance rollers 15 to bow the paper 8 (FIG. 4).

By excessively conveying the paper 8 while the paper 8 is contacting the gate device 13, a skew of the leading edge of the paper 8 is corrected. In this state, the resist rollers 14 are closed as indicated by arrows E in FIG. 5 to press against the paper 8, and therefore, the leading edge of the paper 8 is positioned at a position of the gate device 13 (FIG. 5).

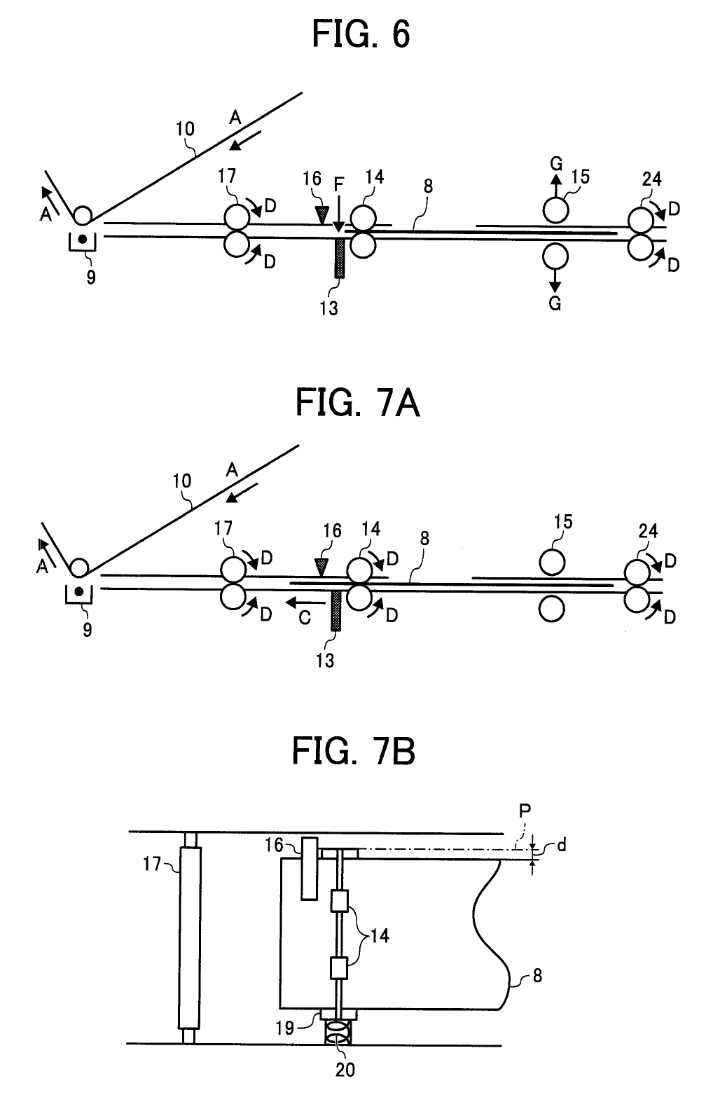

Subsequently, the gate device 13 is opened in a direction indicated by an arrow F in FIG. 6 to be retracted from a paper conveyance path. The conveyance rollers 15 are separated from each other as indicated by arrows G in FIG. 6 so that the paper 8 is straightened (FIG. 6). In other words, paper misalignment on an upstream side of the resist rollers 14 is also corrected.

Then, the paper 8 is conveyed by the resist rollers 14 at a specified speed in a direction indicated by an arrow C in FIG. 7A so that a leading edge of a toner image conveyed on the transfer belt 10 in the transfer belt rotation direction coincides with a desired position on a leading edge portion of the paper 8 in the paper conveyance direction (FIGS. 7A and 7B).

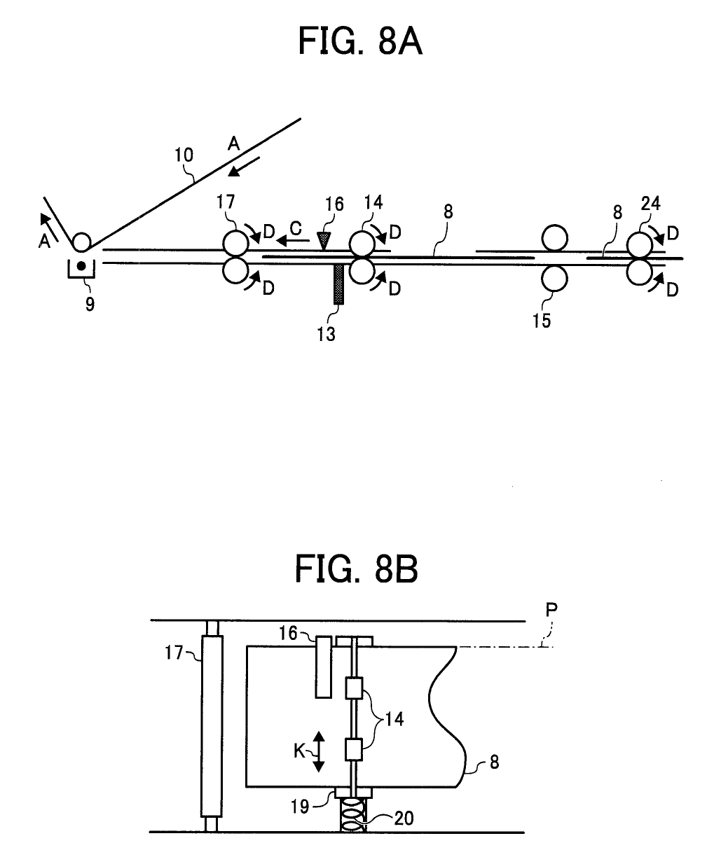

The resist rollers 14 are fixed to a unit frame 19. The unit frame 19 is continuously pressed against a cam 21 by a spring 20. A vertical drive motor 33 (under the control of controller 52) moves the unit frame 19 by rotating the cam 21. Paper misalignment in a direction perpendicular to the paper conveyance direction (the misalignment direction being indicated by an arrow K in FIG. 8B) is corrected by rotating the cam 21 according to a paper misalignment amount d between a position of an edge portion of the paper 8 and a paper feed reference position P. The paper misalignment amount d is measured with the paper detector 16 provided near the unit frame 19 on a downstream side (FIGS. 8A and 8B), and a signal indicative of the paper misalignment amount d is provided to controller 52.

Next, when the leading edge of the paper 8 reaches a nip between the timing rollers 17 and is ready for being conveyed by the timing rollers 17, the resist rollers 14 are separated from each other as indicated by arrows I in FIG. 9A to prepare for positioning a next sheet of paper (FIG. 9A). After the resist rollers 14 complete the separation operation, the unit frame 19 returns to a home position by reversely rotating the cam 21 to respond to vertical misalignment of the next sheet of paper. Further, when the trailing edge of the paper 8 passes the conveyance rollers 15, the conveyance rollers 15 press against each other as indicated by arrows H in FIG. 9A to prepare for conveying the next sheet of paper (FIGS. 9A and 9B).

When the trailing edge of the paper 8 has passed the gate device 13, the gate device 13 is closed in a direction indicated by an arrow J in FIG. 10 to block the paper conveyance path and waits for the next sheet of paper. (FIG. 10)

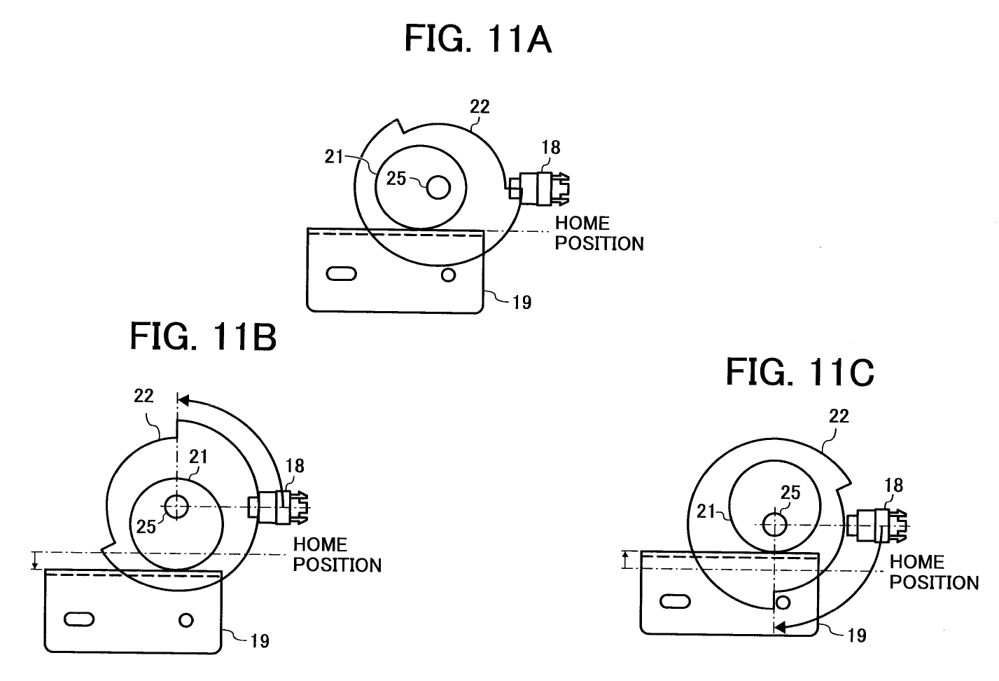

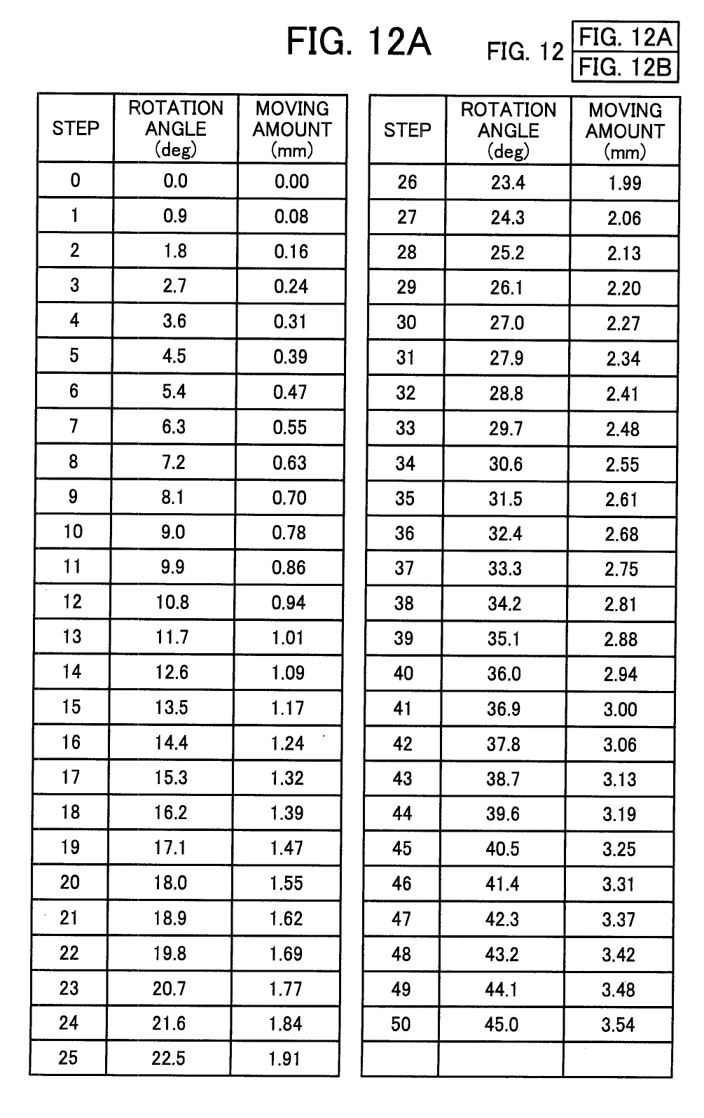

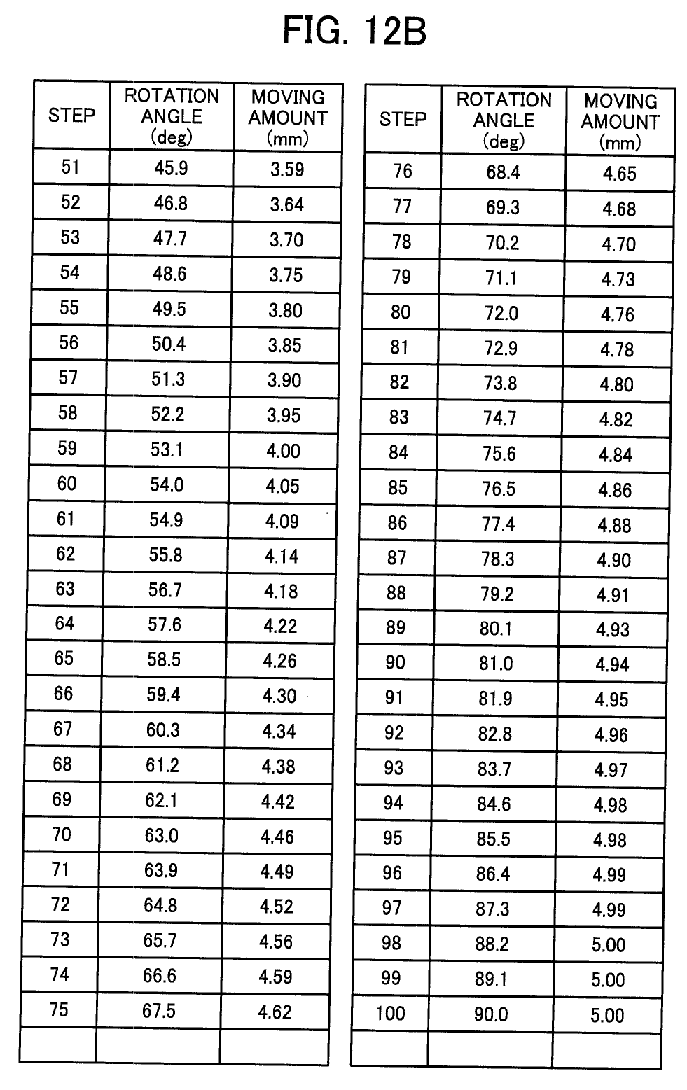

FIG. 11A illustrates a state in which the unit frame 19 is positioned at the home position, FIG. 11B illustrates a state in which the cam 21 is rotated in a counterclockwise direction by 90 degrees, and FIG. 11C illustrates a state in which the cam 21 is rotated in a clockwise direction by 90 degrees. A sensor plate 22 is connected to a motor axis 25 of the vertical drive motor 33. A home position of the vertical drive motor 33 is controlled by setting the home position of the vertical drive motor 33 to a position of the vertical drive motor 33 where the sensor plate 22 detects a position sensor 18. In this case, a stepper motor can be used for the vertical drive motor 33 and can be driven using a microstep method. FIGS. 12A and 12B illustrate a table of sample hypothetical movement increments (per step, respectively) in 1-2 phase excitation mode. Referring to FIGS. 12A and 12B, for example, when a stepper motor with a step angle, e.g., of 0.9 degrees is used and the cam 21 is configured to move the unit frame 19 by, e.g., 5 mm in a paper width direction perpendicular to the paper conveyance direction by rotating the stepper motor 90 degrees in 1-2 phase excitation mode, the stepper motor can take 100 steps, and therefore, a movement error with respect to the paper misalignment amount d can be reduced. Even if a drive frequency of the stepper motor is fixed at a self-starting frequency of, e.g., 1,000 PPS (Pulse Per Second), the movement can be completed in 100 milliseconds.

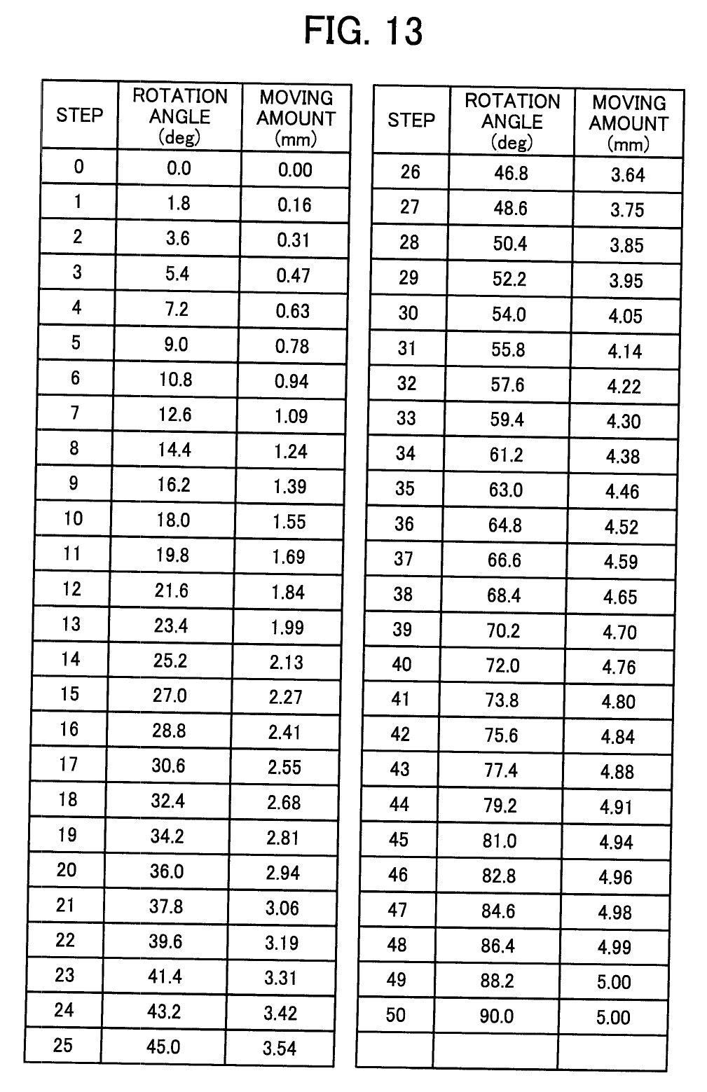

Using an acceleration table can further reduce a time period required for moving the unit frame 19. Such a table can be stored, e.g., in a memory (not depicted) of controller 52. By reducing the time period required for moving the unit frame 19, a distance between the timing rollers 17 and the paper detector 16 can also be reduced. As a result, after the resist rollers 14 are separated from each other, the unit frame 19 finishes returning process to return to the home position while the paper 8 is still being conveyed between the resist rollers 14 (FIGS. 9A and 9B). The time period for moving the unit frame 19 can be reduced at a rotation speed identical to a rotation speed in 1-2 phase excitation mode by driving the stepper motor in, for example, 2-phase excitation mode. FIG. 13 illustrates a table of movement increments (per step, respectively) in 2-phase excitation mode. Further, a DC motor may be used instead of a stepper motor.

By repeating the operation described above, an image forming apparatus capable of high speed paper feeding can be achieved regardless of a distance between sheets of paper.

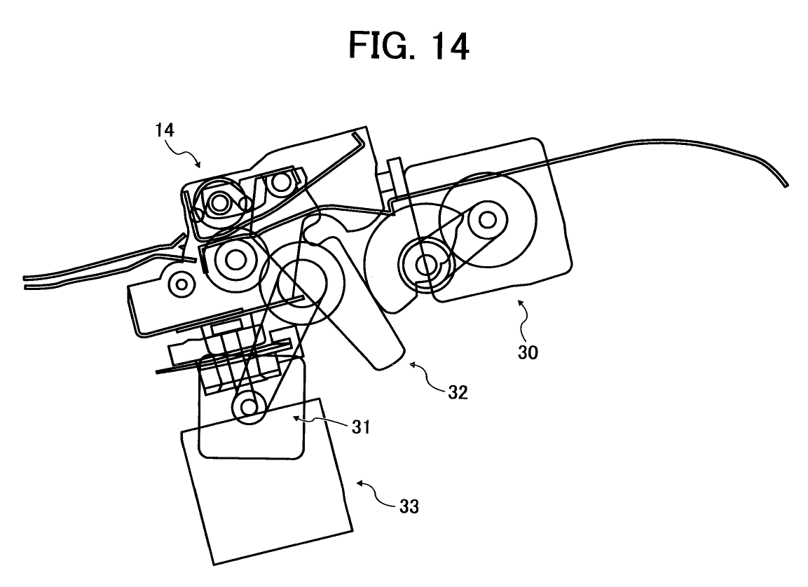

FIG. 14 illustrates a drive mechanism to move the resist rollers 14, to rotate the resist rollers 14, and to move the unit frame 19 including the resist rollers 14. In FIG. 14, the opening and closing motor 30 drives the resist rollers 14 so that the resist rollers 14 contact each other and are separated from each other. A carrying motor 31 rotationally drives one of the resist rollers 14. A link mechanism 32 links the carrying motor 31 and the resist rollers 14. The vertical drive motor 33 moves the unit frame 19. As described above, a stepper motor is used for the vertical drive motor 33. By rotating the vertical drive motor 33, the cam 21 rotates according to the paper misalignment amount d to move the unit frame 19. Thus, paper misalignment in the direction perpendicular to the paper conveyance direction (the direction indicated by an arrow K in FIG. 9B) is to be corrected.

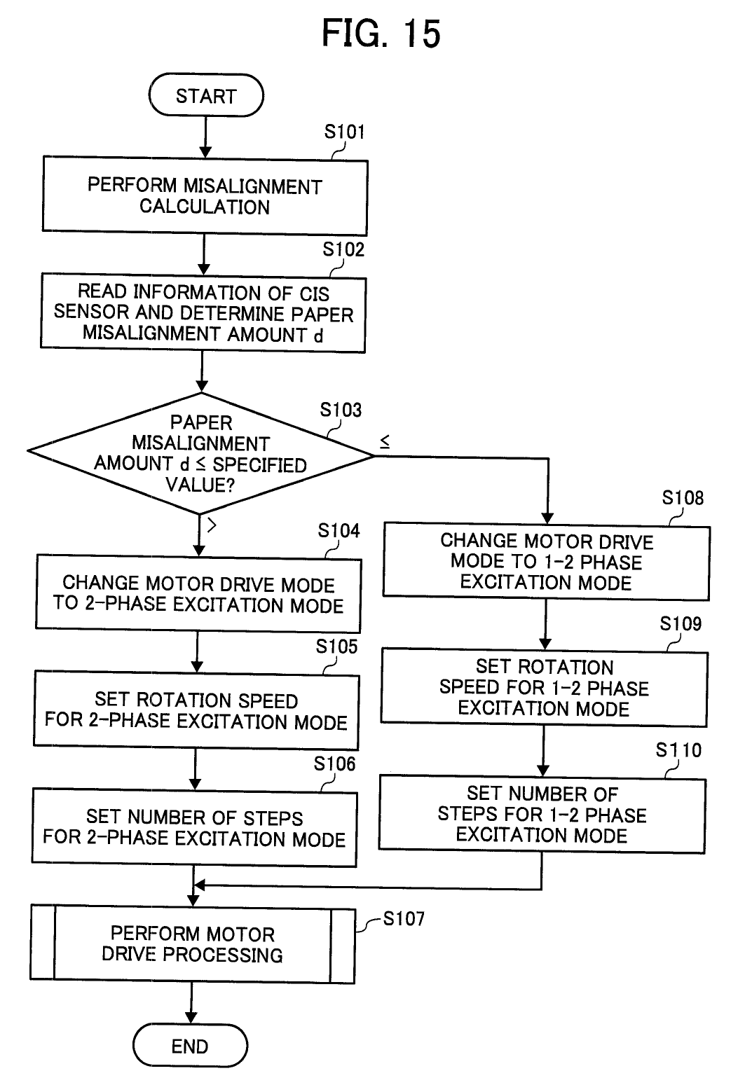

FIGS. 15 through 19 are flow charts for specifically illustrating the operation described above. An arithmetic and control unit such as a computer, e.g., controller 52, is used for control in the following operations.

FIG. 15 is a flow chart illustrating an operation of changing a drive mode and a rotation speed of the vertical drive motor 33 according to the paper misalignment amount d. First, misalignment calculation is performed (Step 101). (Step is abbreviated as S hereinafter.) The paper misalignment amount d is determined by reading information of a CIS sensor (contact image sensor) (S102). Although the CIS sensor is used in the embodiment shown, the paper detector 16 may use any sensor other than the CIS sensor as well. Then, the paper misalignment amount d is checked to determine whether the paper misalignment amount d is equal to or less than a reference specified value (S103). When the paper misalignment amount d exceeds the specified value, the drive mode of the vertical drive motor 33 is changed to 2-phase excitation mode (S104). A rotation speed for 2-phase excitation mode is set (S105). A number of steps for 2-phase excitation mode is set (S106). Drive processing of the vertical drive motor 33 is performed to move the unit frame 19 (S107), and the series of processing ends. When the paper misalignment amount d is equal to or less than the specified value at S103, the drive mode of the vertical drive motor 33 is changed to 1-2 phase excitation mode (S108). A rotation speed for 1-2 phase excitation mode is set (S109). A number of steps for 1-2 phase excitation mode is set (S110). Drive processing of the vertical drive motor 33 is performed to move the unit frame 19 (S107), and the series of processing ends.

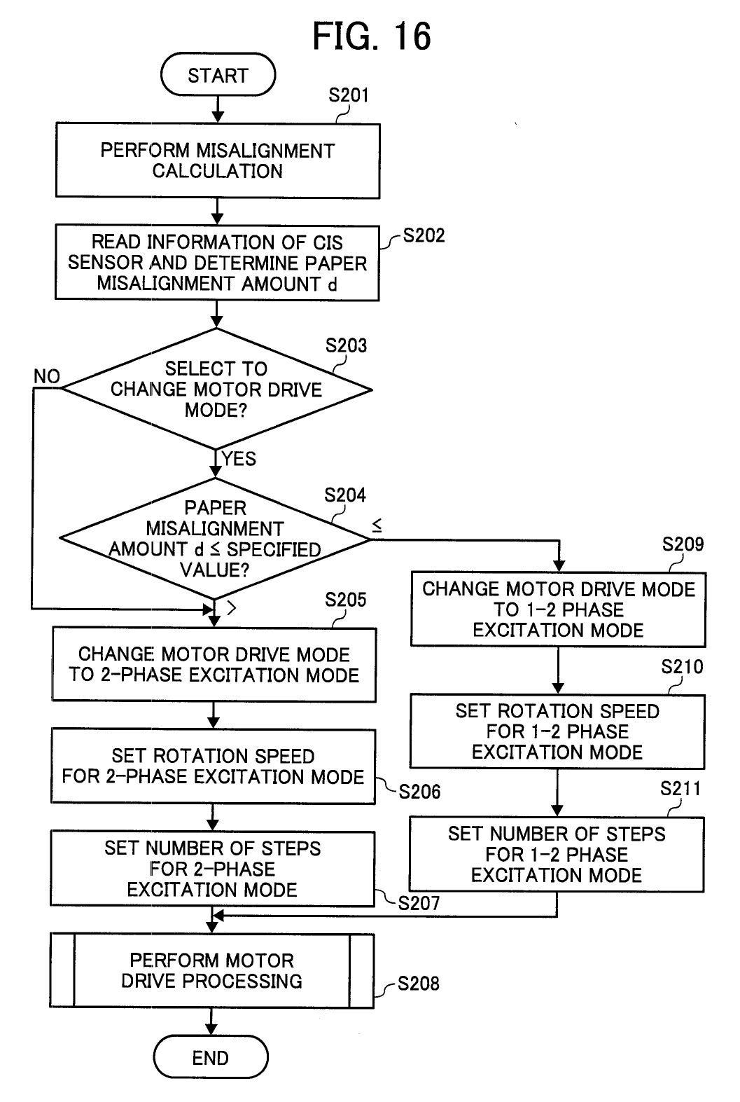

FIG. 16 is a flow chart illustrating an operation of selecting to change the drive mode and the rotation speed of the vertical drive motor 33 according to the paper misalignment amount d. First, misalignment calculation is performed (S201). The paper misalignment amount d is determined by reading information of the CIS sensor (S202). Then, whether to select to change the drive mode is determined (S203). When changing the drive mode is selected (YES in S203), the paper misalignment amount d is checked to determine whether the paper misalignment amount d is equal to or less than a specified value (S204). When the paper misalignment amount d exceeds the specified value, the drive mode of the vertical drive motor 33 is changed to 2-phase excitation mode (S205). A rotation speed for 2-phase excitation mode is set (S206). A number of steps for 2-phase excitation mode is set (S207). Drive processing of the vertical drive motor 33 is performed (S208), and the series of processing ends. When changing the drive mode is not selected (NO in S203), S204 is skipped and the processing proceeds to S205. When the paper misalignment amount d is equal to or less than the specified value at S204, the drive mode of the vertical drive motor 33 is changed to 1-2 phase excitation mode (S209). A rotation speed for 1-2 phase excitation mode is set (S210). A number of steps for 1-2 phase excitation mode is set (S211). Drive processing of the vertical drive motor 33 is performed (S208), and the series of processing ends.

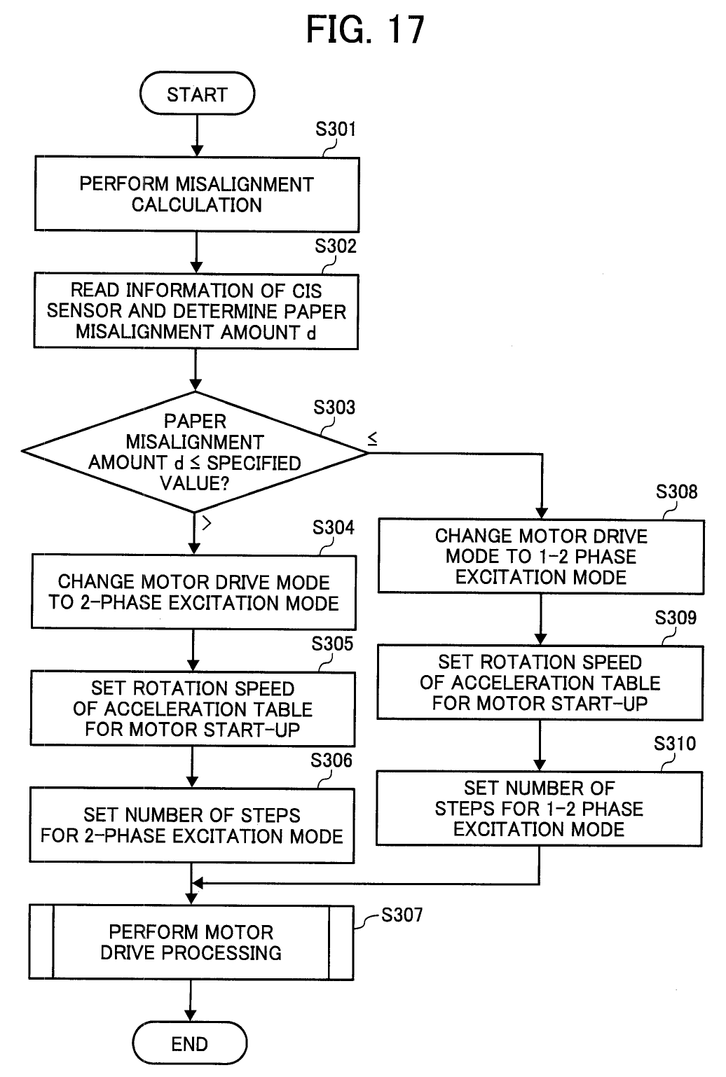

FIG. 17 is a flow chart illustrating an operation of driving the vertical drive motor 33 by controlling the rotation speed according to an acceleration table for motor start-up. First, misalignment calculation is performed (S301). The paper misalignment amount d is determined by reading information of the CIS sensor (S302). Then, the paper misalignment amount d is checked to determine whether the paper misalignment amount d is equal to or less than a specified value (S303). When the paper misalignment amount d exceeds the specified value, the drive mode of the vertical drive motor 33 is changed to 2-phase excitation mode (S304). A rotation speed of the acceleration table for motor start-up is set (S305). A number of steps for 2-phase excitation mode is set (S306). Drive processing of the vertical drive motor 33 is performed to move the unit frame 19 (S307), and the series of processing ends. When the paper misalignment amount d is equal to or less than the specified value at S303, the drive mode of the vertical drive motor 33 is changed to 1-2 phase excitation mode (S308). The rotation speed of the acceleration table for motor start-up is set (S309). A number of steps for 1-2 phase excitation mode is set (S310). Drive processing of the vertical drive motor 33 is performed to move the unit frame 19 (S307), and the series of processing ends.

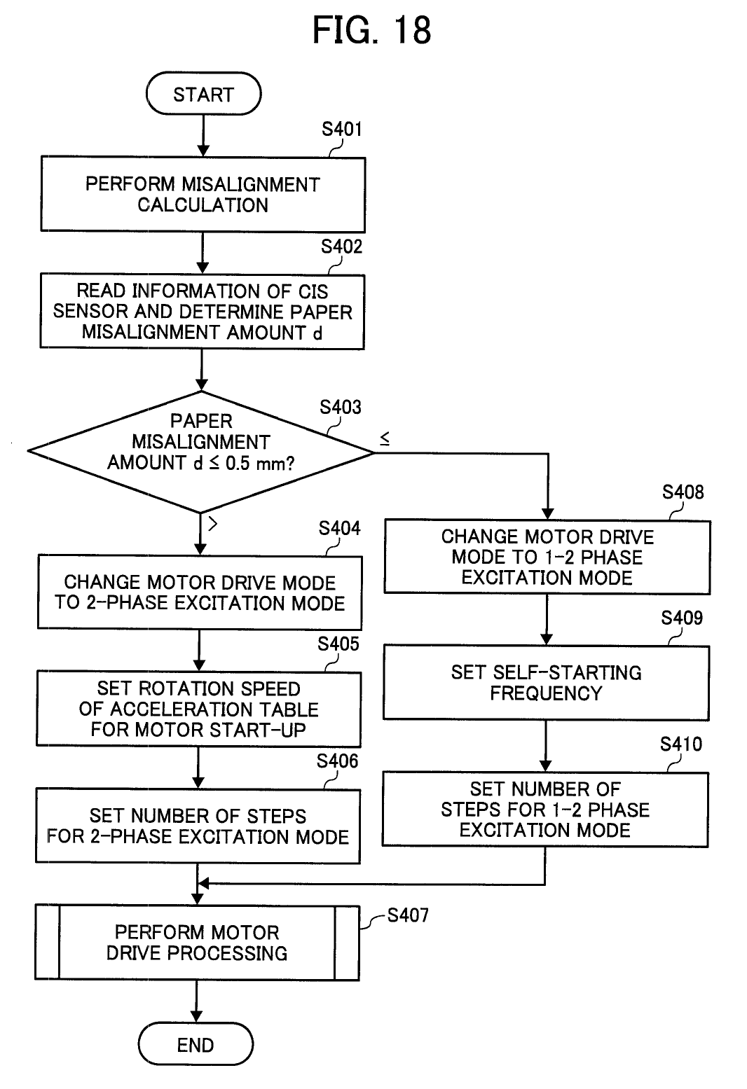

FIG. 18 is a flow chart illustrating an operation of driving the vertical drive motor 33 by fixing the rotation speed at a self-starting frequency of the vertical drive motor 33 when the paper misalignment amount d is equal to or less than a reference value, and for driving the vertical drive motor 33 according to an acceleration table for motor start-up when the paper misalignment amount d is more than the reference value. First, misalignment calculation is performed (S401). The paper misalignment amount d is determined by reading information of the CIS sensor (S402). Then, the paper misalignment amount d is checked to determine whether the paper misalignment amount d is equal to or less than 0.5 mm (S403). When the paper misalignment amount d exceeds 0.5 mm, the drive mode of the vertical drive motor 33 is changed to 2-phase excitation mode (S404). A rotation speed of the acceleration table for motor start-up is set (S405). A number of steps for 2-phase excitation mode is set (S406). Drive processing of the vertical drive motor 33 is performed to move the unit frame 19 (S407), and the series of processing ends. When the paper misalignment amount d is equal to or less than 0.5 mm at S403, the drive mode of the vertical drive motor 33 is changed to 1-2 phase excitation mode (S408). The self-starting frequency of the vertical drive motor 33 is set (S409). A number of steps for 1-2 phase excitation mode is set (S410). Drive processing of the vertical drive motor 33 is performed to move the unit frame 19 (S407), and the series of processing ends.

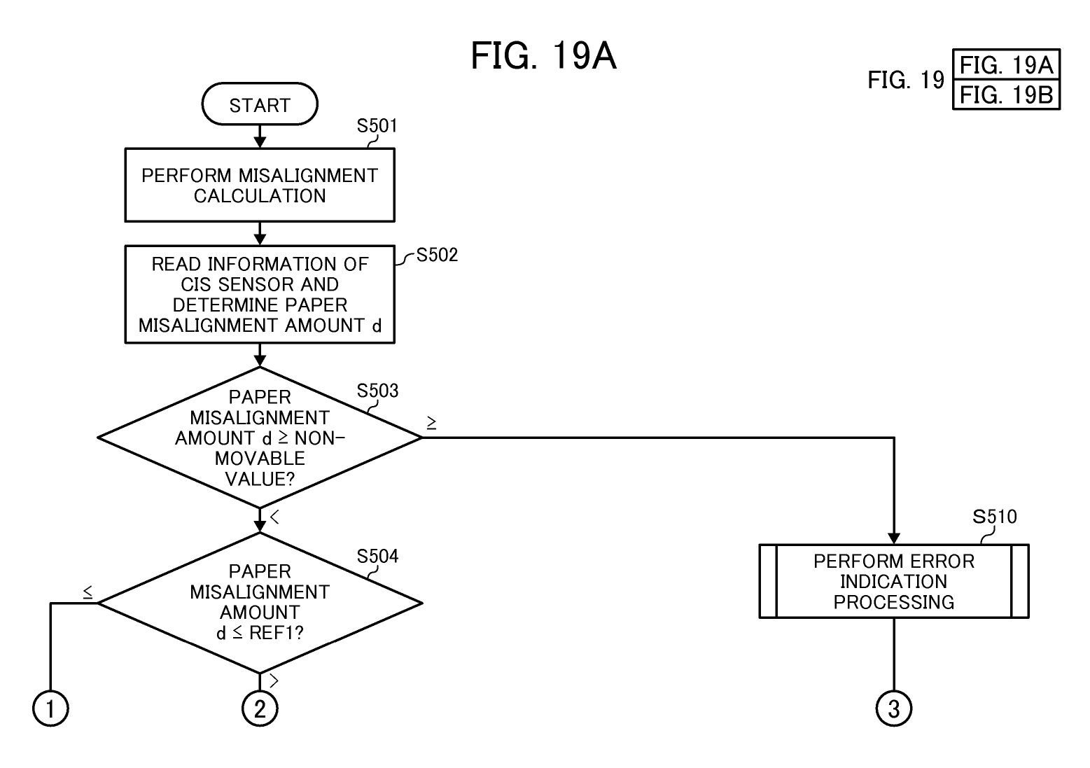

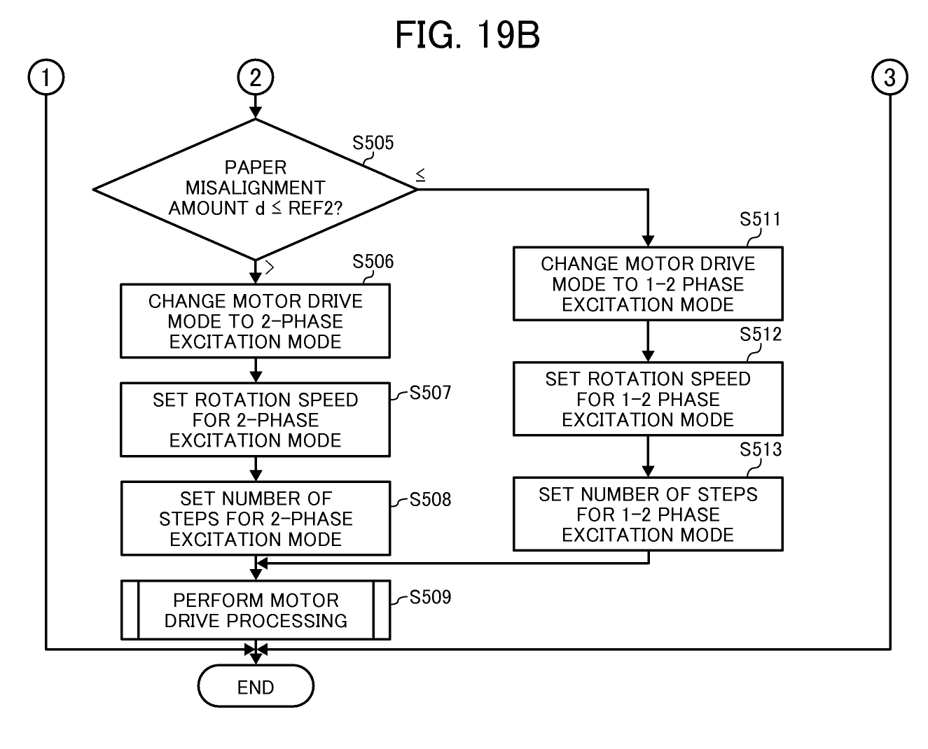

FIGS. 19A and 19B are a flow chart illustrating an operation of preventing the vertical drive motor 33 from driving when the paper misalignment amount d is equal to or less than a reference value. First, misalignment calculation is performed (S501). The paper misalignment amount d is determined by reading information of the CIS sensor (S502). Then, the paper misalignment amount d is checked to determine whether the paper misalignment amount d is equal to or more than a reference non-movable value (S503). When the paper misalignment amount d is less than the non-movable value, the paper misalignment amount d is checked to determine whether the paper misalignment amount d is equal to or less than a first reference value, REF1 (S504).

When the paper misalignment amount d exceeds the first reference value, the paper misalignment amount d is checked to determine whether the paper misalignment amount d is equal to or less than a second reference value, REF2 (S505). When the paper misalignment amount d exceeds the second reference value, the drive mode of the vertical drive motor 33 is changed to 2-phase excitation mode (S506). A rotation speed for 2-phase excitation mode is set (S507). A number of steps for 2-phase excitation mode is set (S508). Drive processing of the vertical drive motor 33 is performed to move the unit frame 19 (S509), and the series of processing ends. When the paper misalignment amount d is equal to or more than the non-movable value at S503, error indication processing is performed (S510), and the series of processing ends.

When the paper misalignment amount d is equal to or less than the first reference value at S504, the processing ends. When the paper misalignment amount d is equal to or less than the second reference value at S505, the drive mode of the vertical drive motor 33 is changed to 1-2 phase excitation mode (S511). A rotation speed for 1-2 phase excitation mode is set (S512). A number of steps for 1-2 phase excitation mode is set (S513). Drive processing of the vertical drive motor 33 is performed to move the unit frame 19 (S509), and the series of processing ends. In the error indication processing at S510, an error message is displayed and/or transmitted to another apparatus.

Numerous additional modifications and variations are possible in light of the above teachings. It is therefore to be understood that, within the scope of the appended claims, the disclosure of this patent specification may be practiced otherwise than as specifically described herein.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetic storage media, including but not limited to floppy disks™, cassette tapes, and removable hard disks; media with a built-in rewriteable non-volatile memory, including but not limited to memory cards; and media with a built-in ROM, including but not limited to ROM cassettes, etc. Furthermore, various information regarding stored images, for example, property information, may be stored in any other form, or provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A sheet conveying apparatus comprising:
a gate member configured to selectively block a sheet conveyance path thereby providing a structure against which to locate a leading edge of a sheet of an image-bearing medium;
resist rollers provided upstream in a sheet conveyance direction vis-à-vis the gate member and configured to convey the sheet downstream to the gate member in the sheet conveyance direction;
a detector provided downstream in the sheet conveyance direction vis-à-vis the gate member and configured to detect misalignment at an edge portion of the sheet in a sheet width direction perpendicular to the sheet conveyance direction;
a moving mechanism, including a motor, configured to move the resist rollers in the sheet width direction; and
a controller configured to change control the moving mechanism by changing a drive mode and a rotation speed of the motor in accordance with a sheet misalignment amount detected by the detector.

2. The sheet conveying apparatus of claim 1, wherein the sheet conveyance path has an opening.

3. The sheet conveying apparatus of claim 1, wherein selection of the drive mode and the rotation speed of the motor is possible.

4. The sheet conveying apparatus of claim 1, wherein the motor includes a stepper motor.

5. The sheet conveying apparatus of claim 4, wherein the stepper motor is driven using a microstep method.

6. The sheet conveying apparatus of claim 4, wherein the stepper motor is driven in 1-2 phase excitation mode using a microstep method.

7. The sheet conveying apparatus of claim 4, wherein the stepper motor is driven in 2-phase excitation mode.

8. The sheet conveying apparatus of claim 4, wherein the stepper motor is configured to be driven at a rotation speed in accordance with an acceleration table for motor start-up.

9. The sheet conveying apparatus of claim 4, wherein the stepper motor is configured to be driven at a rotation speed fixed at a self-starting frequency of the stepper motor when the sheet misalignment amount is equal to or less than a reference value, and to be driven in accordance with an acceleration table for motor start-up when the sheet misalignment amount is more than the reference value.

10. The sheet conveying apparatus of claim 4, wherein the stepper motor is driven using a microstep method when the sheet misalignment amount is equal to or less than a reference value.

11. The sheet conveying apparatus of claim 1, wherein the motor is not driven when the sheet misalignment amount is equal to or less than a reference value.

12. The sheet conveying apparatus of claim 1, wherein an error is indicated when the sheet misalignment amount is equal to or more than a reference value without driving the motor.

13. An image forming apparatus comprising:
a photoconductive member;
at least one toner-image-forming (TIF) unit to form at least one toner image on the photoconductive member, each TIF unit including a charging device, an exposure device and a development device;
a first transfer device to transfer the at least one toner image from the photoconductive member to a transfer member;
a second transfer device to transfer the at least one toner image from the transfer member to one or more sheets of an image-bearing medium; and
a sheet conveying apparatus as claim 1 to provide the one or more sheets.

14. The image forming apparatus of claim 13 configured to transfer an image to the sheet at a position downstream of the gate member in the sheet conveyance direction.

15. The sheet conveying apparatus of claim 1, wherein the moving mechanism further includes a cam, the motor being operable to rotate the cam.

16. The sheet conveying apparatus of claim 15, further comprising:
a frame to which the resist rollers are mounted;
wherein the moving mechanism further includes a spring coupled to the cam, the spring being disposed to bias the cam against the frame.

17. The sheet conveying apparatus of claim 16, wherein:
the motor is operable to move the resist rollers by rotating the cam; the rotation of the cam causing the frame to move.

18. A sheet conveying apparatus comprising:
gate device for selectively blocking a sheet conveyance path thereby establishing a reference position into which a leading edge of a sheet is disposed, and further for unblocking the sheet conveyance path after such disposition of the sheet;
resist rollers means, provided near the gate device on an upstream side in a sheet conveyance direction, for conveying the sheet downstream to the gate member in the sheet conveyance direction;
detector means, provided near the gate device on a downstream side in the sheet conveyance direction, for detecting misalignment at an edge portion of the sheet in a sheet width direction perpendicular to the sheet conveyance direction;
moving means for moving the resist rollers means in the sheet width direction; and
controller means for controlling the moving means by changing a drive mode and a rotation speed thereof in accordance with a sheet misalignment amount detected by the detector means.

19. An image forming apparatus comprising:
photoconductive means for receiving one or more toner images;
toner-image-forming (TIF) means for forming at least one toner image on the photoconductive means;
first transfer means for transferring the at least one toner image from the photoconductive means to a transfer member;
second transfer means for transferring the at least one toner image from the transfer member to one or more sheets of an image-bearing medium; and
sheet conveying means as in claim 18 for providing the one or more sheets.

20. The image forming apparatus of claim 19, wherein the second transfer means is located downstream of the sheet conveying means in the sheet conveyance direction.
